(19) United States
(12) Patent Application Publication
(10) Pub. No.: US 2011/0213051 A1
(43) Pub. Date: Sep. 1, 2011

(54) Use Of Mixtures In The Preparation Of Impact-Modified Thermoplastic Compositions

(75) Inventors: Andreas SEIDEL, Dormagen (DE); Hans-Jürgen THIEM, Dormagen (DE); Eckhard WENZ, Koln (DE)

(73) Assignee: BAYER MATERIALSCIENCE AG, Leverkusen (DE)

(21) Appl. No.: 13/025,867

(22) Filed: Feb. 11, 2011

(30) Foreign Application Priority Data
Feb. 13, 2010 (EP) 10001490.1

(51) Int. Cl. C08L 51/04; C08J 3/215; C08K 3/04

(52) U.S. Cl. 523/340; 524/523

(57) ABSTRACT

The present invention relates to the use, in a compounding process for the preparation of pigmented impact-modified thermoplastic polymer compositions, of a mixture comprising
A) from 60 to 98 parts by weight, based on the sum of components A and B, of at least one graft polymer, used in powder form, consisting of a rubber-elastic core and a grafted polymer component as the shell,
B) from 2 to 40 parts by weight, based on the sum of components A and B, of at least one inorganic or organic liquid compound, and
C) at least one pigment,
   characterised in that the graft polymer A and/or the pigment C absorbs or adsorbs the liquid inorganic or organic compound B, and the boiling point of component B at normal pressure is below the temperature of the polymer melt during the compounding.

### CROSS REFERENCE TO RELATED APPLICATION

This application claims priority to EP 10001490.1 filed Feb. 13, 2010, the content of which is incorporated herein by reference in its entirety.

### BACKGROUND OF THE INVENTION

1. Field of the Invention

The invention relates to the use of mixtures comprising a pulverulent graft polymer loaded with a volatile inorganic or organic liquid, preferably with water, and at least one pigment in the preparation of impact-modified thermoplastic compositions containing at least one pigment, which compositions are distinguished by improved dispersion of the pigment in the polymer matrix and consequently exhibit improved strength and improved surface properties.

The invention additionally relates to a process for the preparation of impact-modified thermoplastic compositions containing at least one pigment, which compositions are distinguished by improved dispersion of the pigment in the polymer matrix and consequently exhibit improved strength and improved surface properties.

2. Description of Related Art

A technical problem that occurs when incorporating pigments into thermoplastic polymer compositions is that of dispersing the pigments in the polymer matrix completely and uniformly. Apart from colour inhomogeneities and a lack of colour depth, incompletely dispersed pigment agglomerates also result in particular in defects, which adversely affect both the mechanical properties of the polymer compositions, such as their strength and elongation at tear, and the surface properties of the materials. Larger pigment agglomerates lead, for example, to faults and defects on the surface of such compositions, such as pimples, striation and, ultimately, a generally undesirable reduction in the gloss. In a composite with other materials, such surface defects can additionally also have an adverse effect on the adhesion properties of the composite (for example the lacquer adhesion).

Dispersion problems occur in particular with pigments that have strong interparticular bonding forces (van der Waals forces). Carbon-based pigments—for example carbon blacks, graphites, fullerenes, graphenes, activated carbons and carbon nanotubes, which are used in many industrial applications, for example for black colouring, for increasing the electrical or thermal conductivity of the composition, for mechanical strengthening, or also for binding and reducing the volatility of low molecular weight organic compounds such as residual monomers or odoriferous substances—are distinguished by particularly strong interparticular bonding forces and therefore have a particularly pronounced tendency to form agglomerates which can only be broken up again with difficulty on incorporation into thermoplastic polymers.

Various methods are known from the prior art for improving the dispersion of such pigments in thermoplastic polymer compositions.

It is obvious, for example, to increase the specific energy input by means of shear during incorporation of the pigments into the polymer melt in commercial compounding units such as twin-screw extruders or internal kneaders. However, in the case of polymer melts having low viscosity, as is required for good thermoplastic processability (high melt flowability) in most fields of application, the energy input is limited by the technical device. In other cases, the energy input is limited by the thermal load capacity of the polymer melt into which the pigment is to be incorporated. High specific energy inputs naturally lead to high process temperatures which, depending on the polymer, can result in undesirable damage, ageing or even decomposition of the polymer.

A further method consists in using a highly concentrated masterbatch of the pigment in a polymer matrix. However, this method requires a second process step and is therefore often of little interest from the point of view of cost. Furthermore, this method generally produces good pigment dispersion in the end product only if the pigments are already well dispersed in the masterbatch, which means that, ultimately, the actual problem is simply shifted to the preceding process step of preparation of the masterbatch.

A third method consists in using dispersing aids, which reduce the intermolecular interactions between the individual pigment particles or pigment aggregates within a pigment agglomerate and are thereby to facilitate the breaking down of the agglomerates during preparation of the compounds. The dispersing aids used are in particular surface-active waxes or oils, for example polyolefin waxes, paraffin waxes or paraffin oils which are optionally oxidised (polar) or optionally modified by the incorporation of vinyl monomers or grafting with such vinyl monomers, fatty acids, fatty acid esters, fatty alcohols, fatty soaps, fatty acid amides and montan waxes. The disadvantage of using such dispersing aids is that they remain in the polymer composition that is prepared and may therefore advantageously affect the application-related properties of the target products. For example, such waxes in multi-phase blend compositions of a plurality of polymers (for example impact-modified polymers) can adversely affect the phase compatibility of the various polymer components and, as a result, the mechanical properties of the blend composition by becoming concentrated at the phase boundaries. Likewise, such additives can catalyse undesirable ageing processes in some polymer systems, for example hydrolytic decomposition reactions in polycondensation polymers.

A further disadvantage of using such dispersing aids is that the pigments mixed or wetted with the dispersing agents must often be introduced directly into the melt of the polymers or polymer mixtures because, owing to the wax that is present, the pigments so treated become compacted when mixed and conveyed with polymers or polymer mixtures in the solid state, which stands in the way of optimum dispersion of the pigment agglomerates in the subsequent melting and dispersing step.

A fourth method consists in metering the pigment in the form of powder mixtures which contain the pigment in admixture with a large excess of the or one of the polymeric components into which the pigment is to be introduced and dispersed. However, this method generally results in an improvement in pigment dispersion that is not entirely satisfactory for many applications. Moreover, the method requires the production of very finely divided polymer powders from polymers that are generally obtained in granulate form in the production process, for example by grinding. This additional process step leads to an undesirable increase in the manufacturing costs of the pigmented polymer compositions, or even to damage to the polymer.

In the preparation of impact-modified compositions it is possible, as an alternative, to meter the pigment in the form of powder premixtures which contain the pigment in admixture with the rubber-containing graft polymers, often in powder form, which are used as impact modifier. Many pigments, however, in particular carbon-based pigments, have a tendency during the preparation of such blends to form clumps owing to their high affinity for the graft polymer powders, by forming sparingly dispersible agglomerates consisting of pigment and graft polymer particles. For this reason, it is particularly difficult to prepare impact-modified polymer compositions containing such added pigments in which both the pigment particles and the graft particles are well dispersed, as is necessary to achieve good mechanical properties and defect-free surfaces. Such preparation often requires a technical detour via a further compounding step, in which a precompound is first prepared from the graft polymer and at least one further polymer component of the target composition. Such precompounding naturally results in an increase in the manufacturing costs of the pigmented polymer compositions and potentially in damage to the polymers, and is therefore undesirable.

Patent application DE 10 2009 009680 discloses a compounding process for the preparation of impact-modified thermoplastic compositions having a reduced content of volatile organic compounds using a powder mixture containing pulverulent graft polymer, water and optionally polymer additives, for example also pigments, the mixture having a water content of from 2 to 40 wt. %. This application is silent regarding an improvement in the pigment dispersion, in particular when using sparingly dispersible carbon-based pigments, in such a process.

### SUMMARY OF THE INVENTION

An object of the present invention was to improve the dispersion of sparingly dispersible pigments in impact-modified thermoplastic polymer compositions in a one-step and accordingly cost-efficient compounding process in order thus to improve the strength and the surface properties of the impact-modified thermoplastic compositions.

A further object of the invention was to provide a process for the preparation of impact-modified thermoplastic compositions containing sparingly dispersible pigments, in particular carbon-based pigments, which compositions are distinguished by improved dispersion of the pigment in the polymer matrix and accordingly exhibit improved strength and improved surface properties.

The first object can be achieved by the use, in a compounding process for the preparation of pigmented impact-modified thermoplastic polymer compositions, of a mixture comprising

A) from 60 to 98 parts by weight, preferably from 68 to 95 parts by weight, in particular from 75 to 92 parts by weight, based on the sum of components A and B, of at least one graft polymer, used in powder form, consisting of a rubber-elastic core and a grafted polymer component as the shell,

B) from 2 to 40 parts by weight, preferably from 5 to 32 parts by weight, in particular from 8 to 25 parts by weight, based on the sum of components A and B, of at least one inorganic or organic liquid compound, and

C) at least one pigment,

characterised in that the liquid inorganic or organic compound B is absorbed or adsorbed by the graft polymer A and/or pigment C, and the boiling point of component B at normal pressure (1 bar) is below the temperature of the polymer melt during the compounding.

The second object can be achieved by a process for the preparation of impact-modified thermoplastic compositions containing at least one pigment, in which

(i) in a first process step there is prepared a mixture comprising

A) from 60 to 98 parts by weight, preferably from 68 to 95 parts by weight, in particular from 75 to 92 parts by weight, based on the sum of components A and B, of at least one graft polymer, used in powder form, consisting of a rubber-elastic core and a grafted polymer component as the shell,

B) from 2 to 40 parts by weight, preferably from 5 to 32 parts by weight, in particular from 8 to 25 parts by weight, based on the sum of components A and B, of at least one inorganic or organic liquid compound,

and

C) at least one pigment,

characterised in that

the liquid inorganic or organic compound B is absorbed or adsorbed by the graft polymer A and/or the pigment C, and

the boiling point of component B at normal pressure (1 bar) is below the temperature of the polymer melt in the degassing zone in process step (ii),

(ii) and in a second process step

from 20 to 99 parts by weight, preferably from 70 to 98 parts by weight, in particular from 80 to 97 parts by weight, based on the sum of the components used in the second process step, of a component (TP) selected from the group consisting of at least one thermoplastic polymer or a mixture of at least one thermoplastic polymer and at least one graft polymer consisting of a rubber-elastic core and a grafted polymer component as the shell according to component A,

from 1 to 80 parts by weight, preferably from 2 to 30 parts by weight, in particular from 3 to 20 parts by weight, based on the sum of the components used in the second process step, of the mixture prepared in step (i)

and

optionally up to 40 parts by weight, preferably up to 25 parts by weight, in particular up to 15 parts by weight, based on the sum of the components used in the second process step, of further components D are mixed, heated by introducing mechanical and thermal energy, melted and dispersed in one another, and the inorganic or organic compound B is removed from the alloyed polymer melt so prepared by application of a partial vacuum.

### DETAILED DESCRIPTION OF A PREFERRED EMBODIMENT

Within the scope of the present invention, a “liquid compound” according to component B is to be understood as being a compound that is liquid under normal conditions (1 bar, 25° C.). In a preferred embodiment, water is used as the liquid compound B in the mixture.

If a mixture of a plurality of liquid compounds is used as component B, then the temperature of the process on removal of the liquid, that is to say the temperature of the polymer melt in the degassing zone of the compounding unit, in process step (ii) is preferably chosen to be above the boiling point of the highest boiling compound in component B, that is to say above the boiling point of the azeotropic mixture, in each case at normal pressure (1 bar).

The pigment of component C is preferably a representative selected from the group consisting of carbon black, graphite, fullerene, graphene, activated carbon and carbon nanotubes. Carbon black is particularly preferably used as the pigment.

In a particular embodiment, the thermoplastic polymer in process step (ii) is a rubber-modified thermoplastic polymer or a blend of at least two polymers with at least one optionally rubber-modified thermoplastic polymer.

In a further particular embodiment, the thermoplastic polymers in process step (ii) also include polymer compositions and blends to which additives have already been added.

Components A and C are used in the mixture according to process step (i) preferably in a weight ratio of from 1:25 to 500:1, preferably from 1:1 to 100:1, in particular from 3:1 to 50:1.

In a further preferred embodiment, some or all of component D is used also as a constituent of the mixture according to process step (i).

In a preferred embodiment, component D is present in the mixture according to process step (i) in an amount of from 0 to 80 parts by weight, preferably from 0.5 to 50 parts by weight, in particular from 1 to 30 parts by weight, based on the sum of components A to D in the pulverulent mixture.

In a preferred embodiment, the mixture according to process step (i) is a pourable powder.

In an alternative embodiment, it is possible to add to the mixture of components A to D according to process step (i) also an amount of thermoplastic polymers (TP) or an amount of different additives according to component D in granulate form. This serves to improve mixing and dispersion of the powder components even during the preparation of the powder mixture in process step (i).

The thermoplastic polymers in granulate form are used in the mixture according to process step (i) in an amount of from 0 to 30 parts by weight, preferably from 0.5 to 20 parts by weight, in particular from 1 to 10 parts by weight, based on the sum of all the components in the mixture according to process step (i).

There can be used as thermoplastic polymers TP in process step (ii), for example, polyolefins (such as polyethylene and polypropylene), vinyl (co)polymers (such as polyvinyl chloride, styrene (co)polymers (e.g. styrene-acrylonitrile copolymers, acrylonitrile-butadiene-styrene copolymers), polyacrylates, polyacrylonitrile), polyvinyl acetate, thermoplastic polyurethanes, polyacetals (such as polyoxymethylene and polyphenylene ether), polyamides, polyimides, polycarbonates, polyesters, polyester carbonates, polysulfones, polyarylates, polyaryl ethers, polyphenylene ethers, polyarylsulfones, polyaryl sulfides, polyether sulfones, polyphenylene sulfide, polyether ketones, polyamideimides, polyether imides and polyester imides.

In a preferred embodiment there is used as the thermoplastic polymer (TP) in process step (ii) at least one representative selected from the group of the aromatic polycarbonates, aromatic polyester carbonates, aromatic polyesters, polyamides and optionally rubber-modified vinyl (co)polymers, as well as blends of at least two of the above-mentioned polymers.

In a particularly preferred embodiment there is used as the thermoplastic polymer (TP) in process step (ii) at least one representative selected from the group of the aromatic polycarbonates and aromatic polyesters, optionally in admixture with at least one optionally rubber-modified vinyl (co)polymer.

Aromatic polycarbonates suitable according to the invention as the thermoplastic polymer (TP) are known in the literature or can be prepared by processes known in the literature (for the preparation of aromatic polycarbonates see, for example, Schnell, “Chemistry and Physics of Polycarbonates”, Interscience Publishers, 1964 as well as DE-AS 1 495 626, DE-A 2 232 877, DE-A 2 703 376, DE-A 2 714 544, DE-A 3 000 610, DE-A 3 832 396; for the preparation of aromatic polyester carbonates see e.g. DE-A 3 077 934).

The preparation of aromatic polycarbonates is carried out, for example, by reaction of diphenols with carbonic acid halides, preferably phosgene, and/or with aromatic dicarboxylic acid dihalides, preferably benzenedicarboxylic acid dihalides, according to the interfacial process, optionally using chain terminators, for example monophenols, and optionally using branching agents having a functionality of three or more than three, for example triphenols or tetraphenols. Preparation by a melt polymerisation process by reaction of diphenols with, for example, diphenyl carbonate is also possible.

Diphenols for the preparation of the aromatic polycarbonates and/or aromatic polyester carbonates are preferably those of formula (I)

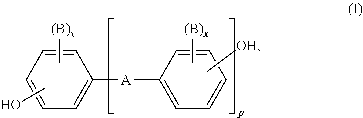

wherein
A is a single bond, C₁ to C₅-alkylene, C₂- to C₅-alkylidene, C₅- to C₆-cycloalkylidene, —O—, —SO—, —CO—, —S—, —SO₂—, C₆- to C₁₂-arylene, to which further aromatic rings optionally containing heteroatoms can be fused,
   or a radical of formula (II) or (III)

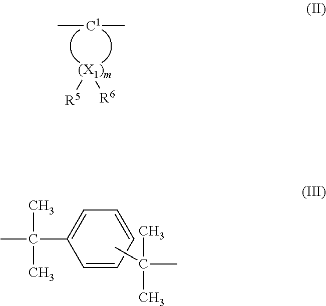

B is in each case C₁- to C₁₂-alkyl, preferably methyl, halogen, preferably chlorine and/or bromine,
x each independently of the other is 0, 1 or 2,
p is 1 or 0, and
R⁵ and R⁶ can be chosen individually for each X¹ and each independently of the other is hydrogen or C₁- to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl) sulfoxides, bis-(hydroxyphenyl)ketones, bis-(hydroxyphenyl)-sulfones and α,α-bis-(hydroxyphenyl)-diisopropyl-benzenes, and derivatives thereof brominated and/or chlorinated on the ring.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone and di- and tetra-brominated or chlorinated derivatives thereof, such as, for example, 2,2-bis(3-chloro-4-hydroxy-phenyl)-propane, 2,2-bis-(3,5-dichloro-4-hydroxyphenyl)-propane or 2,2-bis-(3,5-dibromo-4-hydroxy-phenyl)-propane.

2,2-Bis-(4-hydroxyphenyl)-propane (bisphenol A) is particularly preferred.

Further preferred forms of the polycarbonates and polyester carbonates used in the process according to the invention are disclosed in DE 10 2009 005762 A1, p. 4-7, the relevant content of which is incorporated in this application.

The aromatic polyesters suitable according to the invention as the thermoplastic polymer (TP) are preferably polyalkylene terephthalates, which can be prepared by methods known in the literature (see e.g. Kunststoff-Handbuch, Volume VIII, p. 695 ff, Carl-Hanser-Verlag, Munich 1973).

In a preferred embodiment, the polyalkylene terephthalates are reaction products of aromatic dicarboxylic acids or reactive derivatives thereof, such as dimethyl esters or anhydrides, and aliphatic, cycloaliphatic or araliphatic diols, as well as mixtures of such reaction products.

Particularly preferred polyalkylene terephthalates contain at least 80 wt. %, preferably at least 90 wt. %, based on the dicarboxylic acid component, terephthalic acid radicals and at least 80 wt. %, preferably at least 90 mol %, based on the diol component, ethylene glycol and/or 1,4-butanediol radicals.

Particular preference is given to polyalkylene terephthalates that have been prepared solely from terephthalic acid and reactive derivatives thereof (e.g. dialkyl esters thereof) and ethylene glycol and/or 1,4-butanediol, and mixtures of such polyalkylene terephthalates.

Further preferred forms of the polyalkylene terephthalates used in the process according to the invention are disclosed in DE 10 2009 005762 A1, p. 15-17, the relevant content of which is incorporated in this application.

The vinyl (co)polymers that are preferably suitable according to the invention as the thermoplastic polymer (TP) are rubber-free homo- and/or co-polymers of at least one monomer from the group of the vinyl aromatic compounds, vinyl cyanides (unsaturated nitriles), (meth)acrylic acid (C₁ to C₈)-alkyl esters, unsaturated carboxylic acids and derivatives (such as anhydrides and imides) of unsaturated carboxylic acids.

Particularly suitable are (co)polymers of
from 50 to 99 wt. %, preferably from 60 to 80, in particular from 70 to 80 parts by weight, in each case based on the (co)polymer, of at least one monomer selected from the group of the vinyl aromatic compounds (for example styrene, α-methylstyrene), vinyl aromatic compounds substituted on the ring (for example p-methylstyrene, p-chlorostyrene) and (meth)acrylic acid (C₁-C₈)-alkyl esters (for example methyl methacrylate, n-butyl acrylate, tert-butyl acrylate) and
from 1 to 50 wt. %, preferably from 20 to 40, in particular from 20 to 30 parts by weight, in each case based on the (co)polymer, of at least one monomer selected from the group of the vinyl cyanides (for example unsaturated nitriles such as acrylonitrile and methacrylonitrile), (meth)acrylic acid (C₁-C₈)-alkyl esters (for example methyl methacrylate, n-butyl acrylate, tert-butyl acrylate), unsaturated carboxylic acids and derivatives of unsaturated carboxylic acids (for example maleic anhydride and N-phenyl-maleimide).

The copolymer of styrene and acrylonitrile is particularly preferred.

Such (co)polymers are known and can be prepared by radical polymerisation, in particular by emulsion, suspension, solution or mass polymerisation.

The rubber-modified vinyl (co)polymers that are preferably suitable according to the invention as the thermoplastic polymer (TP) are graft polymers of
from 50 to 95 wt. %, preferably from 60 to 93 wt. %, in particular from 70 to 90 wt. %, based on this graft polymer, of at least one vinyl monomer on
from 5 to 50 wt. %, preferably from 7 to 40 wt. %, in particular from 10 to 30 wt. %, based on this graft polymer, of one or more graft bases having glass transition temperatures <10° C., preferably <0° C., particularly preferably <−20° C.

The glass transition temperature is determined by means of dynamic differential calorimetry (DSC) according to standard DIN EN 61006 at a heating rate of 10 K/min with definition of the T_{g} as the mid-point temperature (tangent method).

The graft base generally has a mean particle size (d₅₀ value) of from 0.05 to 10 μm, preferably from 0.1 to 2 μm.

The mean particle size d₅₀ is the diameter above and below which in each case 50 wt. % of the particles lie. It can be determined by means of ultracentrifuge measurement (W. Scholtan, H. Lange, Kolloid, Z. and Z. Polymere 250 (1972), 782-1796).

Monomers of the graft shell are preferably mixtures of
from 50 to 99 parts by weight, preferably from 60 to 80 parts by weight, in particular from 70 to 80 parts by weight, based on B.1, of vinyl aromatic compounds and/or vinyl aromatic compounds substituted on the ring (such as styrene, α-methylstyrene, p-methylstyrene, p-chlorostyrene) and/or methacrylic acid (C₁-C₈)-alkyl esters (such as methyl methacrylate, ethyl methacrylate) and
from 1 to 50 parts by weight, preferably from 20 to 40 parts by weight, in particular from 20 to 30 parts by weight, based on B.1, of vinyl cyanides (unsaturated nitriles such as acrylonitrile and methacrylonitrile) and/or (meth)acrylic acid (C₁-C₈)-alkyl esters, such as methyl methacrylate, n-butyl acrylate, tert-butyl acrylate, and/or derivatives (such as anhydrides and imides) of unsaturated carboxylic acids, for example maleic anhydride and N-phenyl-maleimide.

Preferably, the graft shell is composed of styrene in combination with acrylonitrile and/or methyl methacrylate, or of pure methyl methacrylate.

Graft bases suitable for the graft polymers are, for example, diene rubbers, EP(D)M rubbers, that is to say those based on ethylene/propylene and optionally diene, acrylate, polyurethane, silicone, chloroprene and ethylene/vinyl acetate rubbers, as well as silicone/acrylate composite rubbers.

Preferred graft bases are diene rubbers, for example based on butadiene and isoprene, or mixtures of diene rubbers or copolymers of diene rubbers or mixtures thereof with further copolymerisable monomers, with the proviso that the glass transition temperature of the graft base is <10° C., preferably <0° C., particularly preferably <−20° C. Pure polybutadiene rubber is particularly preferred.

Further preferred graft bases are acrylate rubbers, in particular those based on butyl acrylate.

Particularly preferred rubber-modified vinyl (co)polymers are ABS polymers (emulsion, mass and suspension ABS), as are described, for example, in DE-OS 2 035 390 (=U.S. Pat. No. 3,644,574) or in DE-OS 2 248 242 (=GB-PS 1 409 275) or in Ullmanns, Enzyklopädie der Technischen Chemie, Vol. 19 (1980), p. 280 ff.

Further preferred rubber-modified vinyl (co)polymers are ASA polymers containing graft polymers of styrene and acrylonitrile grafted onto butyl acrylate rubber and free styrene-acrylonitrile copolymer.

In a preferred embodiment, components A and B are first premixed in process step (i), and then components C and optionally D are mixed in. The inorganic or organic liquid according to component B is thereby adsorbed or absorbed by the graft polymer according to component A, so that both the premixture of components A and B and the mixture of components A, B, C and optionally D constitute pourable mixtures, preferably pourable powder mixtures. The amounts of A and B are accordingly so matched with one another that component B is bonded completely by the graft polymer A. Whether and what amount of component B can be bonded by the graft polymer A ultimately depends both on the nature of component A (in particular its porosity) and on the nature of component B (in particular its polarity and surface tension).

The composition obtained according to process steps (i) and (ii) contains preferably from 0.05 to 15 wt. %, more preferably from 0.1 to 5 wt. % and particularly preferably from 0.2 to 2 wt. % component C.

The compounding unit used in process step (ii) has a melting and mixing zone or a combined melting and mixing zone (this “melting and mixing zone” is also referred to hereinbelow as a “kneading and melting zone”) and a degassing zone, in which an absolute pressure p_{abs} of preferably not more than 800 mbar, more preferably not more than 500 mbar, particularly preferably not more than 200 mbar, is set.

In a preferred embodiment, the temperature of the melt of the polymer or of the polymer alloy in the degassing zone is from 200° C. to 350° C., preferably from 220° C. to 320° C., particularly preferably from 230° C. to 300° C.

The mean residence time for which the melt of the polymer or of the polymer alloy is in contact in process step (ii) with component B, which is introduced into the process via the mixture prepared in process step (i), is preferably limited to not more than 90 seconds, particularly preferably not more than 60 seconds, most particularly preferably not more than 30 seconds.

The compounding unit is preferably a twin-screw extruder, particularly preferably a twin-screw extruder with co-rotating shafts, the twin-screw extruder having a length/diameter ratio of the screw shaft of preferably from 32 to 44, particularly preferably from 34 to 38.

Within the scope of the invention, “powder” or “pulverulent” is understood as meaning a component or a mixture of a plurality of components that is in the solid state of aggregation and in which the particles have mean particle sizes of less than 2 mm, preferably less than 1 mm, in particular less than 0.5 mm.

“Granulate” within the scope of the invention is understood as meaning a component or a mixture of a plurality of components that is in the solid state of aggregation, in which the solid particles have a mean particle size of at least 2 mm and generally not more than 10 mm. The granulate grains can have any desired shape, for example a lenticular shape, a spherical shape or a cylindrical shape.

The invention further provides the compositions prepared by one of the above-described processes according to the invention, and moulded articles produced from such compositions.

Component A

Component A is a pulverulent graft polymer or a mixture of a plurality of pulverulent graft polymers. Graft polymers that are preferably used as component A include one or more graft polymers of
A.1 from 5 to 95 wt. %, preferably from 20 to 90 wt. %, in particular from 25 to 50 wt. %, based on component A, of at least one vinyl monomer on
A.2 from 95 to 5 wt. %, preferably from 80 to 10 wt. %, in particular from 75 to 50 wt. %, based on component B, of one or more graft bases having glass transition temperatures <10° C., preferably <0° C., particularly preferably <−20° C.

The glass transition temperature is determined by means of dynamic differential calorimetry (DSC) according to standard DIN EN 61006 at a heating rate of 10 K/min with definition of the T_{g} as the mid-point temperature (tangent method).

The graft base A.2 generally has a mean particle size (d₅₀ value) of from 0.05 to 10 μm, preferably from 0.1 to 2 μm, particularly preferably from 0.15 to 0.6 μm.

The mean particle size d₅₀ is the diameter above and below which in each case 50 wt. % of the particles lie. It can be determined by means of ultracentrifuge measurement (W. Scholtan, H. Lange, Kolloid, Z. and Z. Polymere 250 (1972), 782-1796).

Monomers A.1 are preferably mixtures of
A.1.1 from 50 to 99 parts by weight, preferably from 60 to 80 parts by weight, in particular from 70 to 80 parts by weight, based on A.1, of vinyl aromatic compounds and/or vinyl aromatic compounds substituted on the ring (such as styrene, α-methylstyrene, p-methylstyrene, p-chlorostyrene) and/or methacrylic acid (C₁-C₈)-alkyl esters (such as methyl methacrylate, ethyl methacrylate) and
A.1.2 from 1 to 50 parts by weight, preferably from 20 to 40 parts by weight, in particular from 20 to 30 parts by weight, based on A.1, of vinyl cyanides (unsaturated nitriles such as acrylonitrile and methacrylonitrile) and/or (meth)acrylic acid (C₁-C₈)-alkyl esters, such as methyl methacrylate, n-butyl acrylate, tert-butyl acrylate, and/or derivatives (such as anhydrides and imides) of unsaturated carboxylic acids, for example maleic anhydride and N-phenyl-maleimide.

Preferred monomers A.1.1 are selected from at least one of the monomers styrene, α-methylstyrene and methyl methacrylate; preferred monomers A.1.2 are selected from at least one of the monomers acrylonitrile, maleic anhydride and methyl methacrylate. Particularly preferred monomers are A.1.1 styrene and A.1.2 acrylonitrile.

Graft bases A.2 suitable for the graft polymers A are, for example, diene rubbers, EP(D)M rubbers, that is to say those based on ethylene/propylene and optionally diene, acrylate, polyurethane, silicone, chloroprene and ethylene/vinyl acetate rubbers, as well as silicone/acrylate composite rubbers.

Preferred graft bases A.2 are diene rubbers, for example based on butadiene and isoprene, or mixtures of diene rubbers or copolymers of diene rubbers or mixtures thereof with further copolymerisable monomers (e.g. according to A.1.1 and A.1.2), with the proviso that the glass transition temperature of component A.2 is <10° C., preferably <0° C., particularly preferably <−20° C. Pure polybutadiene rubber is particularly preferred.

The graft copolymers A are prepared by radical polymerisation, preferably by emulsion polymerisation.

Particularly suitable graft polymers A have a core-shell structure.

The gel content of the graft base A.2 in the case of graft polymers prepared by emulsion polymerisation is at least 30 wt. %, preferably at least 40 wt. % (measured in toluene).

The gel content of the graft base A.2 or of the graft polymers A is determined at 25° C. in a suitable solvent as the fraction that is insoluble in such solvents (M. Hoffmann, H, Krömer, R. Kuhn, Polymeranalytik I and II, Georg Thieme-Verlag, Stuttgart 1977).

Particularly suitable graft rubbers are also ABS polymers, which are prepared by redox initiation with an initiator system comprising organic hydroperoxide and ascorbic acid according to U.S. Pat. No. 4,937,285.

Because it is known that the graft monomers are not necessarily grafted onto the graft base completely during the graft reaction, graft polymers A according to the invention are also understood as being those products which are obtained by (co)polymerisation of the graft monomers in the presence of the graft base and which are formed concomitantly during working up. These products can accordingly also contain (co)polymer of the graft monomers that is free, that is to say not chemically bonded to the rubber.

Suitable acrylate rubbers according to A.2 are preferably polymers of acrylic acid alkyl esters, optionally with up to 40 wt. %, based on A.2, of other polymerisable, ethylenically unsaturated monomers. The preferred polymerisable acrylic acid esters include C₁- to C₈-alkyl esters, for example methyl, ethyl, butyl, n-octyl and 2-ethylhexyl esters; haloalkyl esters, preferably halo-C₁-C₈-alkyl esters, such as chloroethyl acrylate, as well as mixtures of these monomers.

For crosslinking, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and tri-vinylbenzenes; but also triallyl phosphate and diallyl phthalate. Preferred crosslinking monomers are allyl methacrylate, ethylene glycol dimethacrylate, diallyl phthalate, and heterocyclic compounds containing at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinking monomers is preferably from 0.02 to 5 wt. %, in particular from 0.05 to 2 wt. %, based on the graft base A.2. In the case of cyclic crosslinking monomers having at least three ethylenically unsaturated groups, it is advantageous to limit the amount to less than 1 wt. % of the graft base A.2.

Preferred “other” polymerisable, ethylenically unsaturated monomers which can optionally be used, in addition to the acrylic acid esters, to prepare the graft base A.2 are, for example, acrylonitrile, styrene, α-methylstyrene, acrylamides, vinyl C₁-C₆-alkyl ethers, methyl methacrylate, butadiene. Preferred acrylate rubbers as the graft base A.2 are emulsion polymers having a gel content of at least 60 wt. %.

Further suitable graft bases according to A.2 are silicone rubbers having graft-active sites, as are described in DE-OS 3 704 657, DE-OS 3 704 655, DE-OS 3 631 540 and DE-OS 3 631 539.

Component B

There are suitable as component B in principle any inorganic or organic liquid compounds having a boiling point at normal pressure (1 bar) below the temperature of the polymer melt in the degassing zone of the compounding unit in process step (ii), or mixtures of such compounds.

The boiling point of component B under normal pressure is preferably not more than 200° C., more preferably not more than 150° C., yet more preferably not more than 130° C., and particularly preferably from 70 to not more than 120° C.

The use of water as component B is particularly preferred and offers the additional advantages of being readily available, having a low cost factor, being safe to work with and being ecologically harmless.

Further suitable liquid compounds are, for example, methanol, ethanol, n-propanol, isopropanol, dimethylformamide, acetone, n-hexane, cyclohexane, n-heptane, n-octane, toluene, as well as mixtures of these liquids.

In a further preferred embodiment, component B is a mixture of water and at least one further liquid that is partly or completely miscible with water, preferably selected from the group comprising methanol, ethanol, n-propanol, isopropanol, dimethylformamide, acetone, n-hexane, cyclohexane, n-heptane, n-octane and toluene, more preferably an alcohol, and particularly preferably ethanol and isopropanol.

In this embodiment, the water and the further liquid(s) are used in a mixing ratio such that a homogeneous, that is to say single-phase, mixture forms. The water content of such mixtures is preferably at least 50 wt. %, more preferably at least 75 wt. % and particularly preferably at least 90 wt. %.

Component B is preferably so chosen that it can be adsorbed or absorbed by the graft polymer A, so that the mixing of A and B yields a pourable mixture and not a suspension.

Component C

There can be used as component C in principle any desired inorganic or organic, natural or synthetically prepared pigments. A pigment is understood as being a colour-giving substance which is insoluble in the application medium (here the thermoplastic polymer). Examples of such pigments are titanium dioxide, carbon black, bismuth pigments, metal oxides, metal hydroxides, metal sulfides, iron cyan blue, ultramarine, cadmium pigments, chromate pigments, azo pigments and polycyclic pigments.

There are preferably used as component C pigments that have strong interparticular bonding forces (van der Waals forces), because they are particularly difficult to disperse.

Component C is particularly preferably at least one carbon-based pigment selected from the group consisting of carbon black, graphite, fullerene, graphene, activated carbon and carbon nanotubes.

There are suitable as carbon nanotubes both those having a single-layer wall (single-walled carbon nanotubes=SWCNTs) and those having a multi-layer wall (multi-walled carbon nanotubes=MWCNTs).

Carbon nanotubes (CNTs) are preferably understood as being cylindrical carbon nanotubes having a carbon content of >95%, which do not contain amorphous carbon. The carbon nanotubes preferably have an outside diameter of from 3 to 80 nm, particularly preferably from 5 to 20 μm. The mean value of the outside diameter is preferably from 13 to 16 nm. The length of the cylindrical carbon nanotubes is preferably from 0.1 to 20 μm, particularly preferably from 1 to 10 μm. The carbon nanotubes preferably consist of from 2 to 50, particularly preferably from 3 to 15, graphite sheets (also referred to as “layers” or “walls”) which have a smallest inside diameter of from 2 to 6 nm. Such carbon nanotubes are also referred to, for example, as carbon fibrils or hollow carbon fibres.

The preparation of the CNTs used according to the invention is generally known (see e.g. U.S. Pat. No. A 5,643,502 and DE-A 10 2006 017 695). The preparation is preferably carried out according to the process disclosed in DE-A 10 2006 017 695, particularly preferably according to Example 3 of DE-A 10 2006 017 695.

Carbon black is particularly preferably used as component C, any type of carbon black in principle being suitable for use as component C.

Carbon black is a black pulverulent solid which, depending on its quality and use, consists substantially of carbon. The carbon content of carbon black is generally from 80.0 to 99.9 wt. %. In carbon blacks that have not been subjected to oxidative after-treatment, the carbon content is preferably from 96.0 to 95.5 wt. %. Traces of organic impurities on the carbon black can be removed by extracting the carbon black with organic solvents, for example with toluene, and the carbon content can thus be increased to even greater than 99.9 wt. %. In carbon blacks that have been subjected to oxidative after-treatment, the oxygen content can be up to 30 wt. %, preferably up to 20 wt. %, in particular from 5 to 15 wt. %.

Carbon black consists of mostly spherical primary particles having a size of preferably from 10 to 500 nm. These primary particles have grown together to form chain-like or branched aggregates. The aggregates are generally the smallest unit into which the carbon black can be broken in a dispersing process. Many of these aggregates combine again by intermolecular (van der Waals) forces to form agglomerates. Both the size of the primary particles and the aggregation (structure) thereof can be adjusted purposively by varying the preparation conditions. The term structure is understood by the person skilled in the art as meaning the nature of the three-dimensional arrangement of the primary particles in an aggregate. The term “high structure” is used for carbon blacks having highly branched and crosslinked aggregate structures; “low structure”, on the other hand, refers to largely linear aggregate structures, that is to say those with little branching and crosslinking.

The oil adsorption number, measured according to ISO 4656 with dibutyl phthalate (DBP), is generally given as a measure of the structure of a carbon black. A high oil adsorption number is indicative of a high structure.

The primary particle size of a carbon black can be determined, for example, by means of scanning electron microscopy. However, the BET surface area of the carbon black, determined according to ISO 4652 with nitrogen adsorption, is also used as a measure of the primary particle size of a carbon black. A high BET surface area is indicative of a small primary particle size.

The dispersibility of the agglomerates of a carbon black depends on the primary particle size and the structure of the aggregates, the dispersibility of the carbon black generally decreasing as the primary particle size and the structure decrease.

As an industrial product, industrial carbon black is produced by incomplete combustion or pyrolysis of hydrocarbons. Processes for producing industrial carbon black are known in the literature. Known processes for producing industrial carbon blacks are in particular the furnace, gas black, flame black, acetylene black and thermal black processes.

The particle size distribution of the primary particles, as well as the size and structure of the primary particle aggregates, determine properties such as colour depth, base tone and conductivity of the carbon black. Conductive blacks generally have small primary particles and widely branched aggregates. Colour carbon blacks are generally carbon blacks having very small primary particles and are often subjected to subsequent oxidation by one of the above-mentioned processes after they have been produced. The oxidic groups thereby attached to the carbon black surface are to increase the compatibility with the resins in which the colour carbon blacks are to be introduced and dispersed.

Colour carbon blacks are preferably used as component C. In a preferred embodiment, they have a mean primary particle size, determined by scanning electron microscopy, of from 10 to 100 nm, more preferably from 10 to 50 nm, particularly preferably from 10 to 30 nm, in particular from 10 to 20 nm. The particularly finely divided colour carbon blacks are therefore particularly preferred in the process according to the invention because the colour depth and UV resistance achievable with a specific amount of carbon black increases as the primary particle size falls; on the other hand, however, their dispersibility also falls, which is why such very finely divided carbon blacks in particular need an improvement in respect of dispersibility.

The colour carbon blacks preferably used as component C have a BET surface area, determined according to ISO 4652 by nitrogen adsorption, of preferably at least 20 m²/g, more preferably at least 50 m²/g, particularly preferably at least 100 m²/g, in particular at least 150 m²/g.

Colour carbon blacks preferably used as component C are additionally characterised by an oil adsorption number, measured according to ISO 4656 with dibutyl phthalate (DBP), of preferably from 10 to 200 ml/100 g, more preferably from 30 to 150 ml/100 g, particularly preferably from 40 to 120 ml/100 g, in particular from 40 to 80 ml/100 g. The colour carbon blacks having a low oil adsorption number generally achieve a better colour depth and are preferred in that respect but, on the other hand, they are generally more difficult to disperse, which is why such carbon blacks in particular need an improvement in respect of dispersibility.

The carbon blacks used as component C can be and are preferably used in pelletised or pearl form. Pearling or pelletisation is carried out by processes known in the literature and on the one hand is used to increase the bulk density and improve the metering (flow) properties, but on the other hand is also carried out for reasons of hygiene in the workplace. The hardness of the pellets or pearls is preferably so adjusted that they withstand transportation and feeding processes during metering largely undamaged, but break up completely into agglomerates again when subjected to greater mechanical shear forces as are encountered, for example, in commercial powder mixing devices and/or compounding units.

Component D

Component D is selected from the group consisting of commercial polymer additives such as flameproofing agents (for example halogen compounds or phosphorus compounds such as monomeric or oligomeric organic phosphoric acid esters, phosphazenes or phosphonate amines), flameproofing synergists (for example nano-scale metal oxides), smoke-inhibiting additives (for example boric acid or borates), antidripping agents (for example compounds of the substance classes of the fluorinated polyolefins, of the silicones, as well as aramid fibres), internal and external lubricants and demoulding agents (for example pentaerythritol tetrastearate, montan wax or polyethylene wax), flowability aids (for example low molecular weight vinyl (co)polymers), antistatics (for example block copolymers of ethylene oxide and propylene oxide, other polyethers or polyhydroxy ethers, polyether amides, polyester amides or sulfonic acid salts), conductivity additives beyond the definition of component C, stabilisers (for example UV/light stabilisers, heat stabilisers, antioxidants, transesterification inhibitors, hydrolytic stabilisers), additives having antibacterial action (for example silver or silver salts), additives that improve scratch resistance (for example silicone oils or hard fillers such as (hollow) ceramics spheres), IR absorbers, optical brighteners, fluorescent additives, fillers and reinforcing substances beyond the definition of component C (for example talc, optionally ground glass fibres, (hollow) glass or ceramics spheres, mica, kaolin, CaCO₃ and glass flakes) as well as colourings and pigments other than component C, impact modifiers other than component A, ground thermoplastic polymers and Brönstet-acidic compounds as base acceptors, or mixtures of a plurality of the mentioned additives.

### EXAMPLES

### Component A

Graft polymer consisting of 28 wt. % styrene-acrylonitrile copolymer having a ratio of styrene to acrylonitrile of 71 to 29 parts by weight as the shell on 72 wt. % of a particulate graft base as the core, consisting of 46 parts by weight, based on the graft base, silicone rubber and 54 parts by weight, based on the graft base, butyl acrylate rubber, prepared by the emulsion polymerisation process.

### Component B

Water

### Component C

Black Pearls 800 (Capot Corporation, Leuven, Belgium); pearled pigment black having a mean primary particle size, determined by scanning electron microscopy, of 17 nm, a BET surface area, determined according to ISO 4652 by nitrogen adsorption, of 210 m²/g and an oil adsorption number, measured according to ISO 4656 with dibutyl phthalate (DBP), of 65 ml/100 g.

### Component D

Component D1

Pentaerythritol tetrastearate (PETS) used in powder form

Component D2

Irganox B900: pulverulent mixture of 80 wt. % Irgafos 168 (tris-(2,4-di-tert-butyl)phenyl phosphite) and 20 wt. % Irganox 1076 (octadecyl 3-(3,5-di-tert-butyl-4-hydroxyphenyl)propionate) (BASF, Germany, Ludwigshafen)

Component D3

Tinuvin 329: 2-(2H-benzotriazol-2-yl)-4-(1,1,3,3-tetramethylbutyl)phenol used in powder form (BASF, Germany, Ludwigshafen)

Thermoplastic Polymer (TP)

Component TP 1

Linear polycarbonate based on bisphenol A having a weight-average molecular weight M̅_{w} of 25,000 g/mol (determined by GPC in methylene chloride with polycarbonate as standard).

Component TP 2

Styrene-acrylonitrile copolymer having a styrene content of 76 wt. % and an acrylonitrile content of 24 wt. % and a weight-average molecular weight M̅_{w} of 100,000 g/mol (determined by GPC in dimethylformamide with polystyrene as standard).

Preparation and Testing of the Moulding Compositions

The compositions listed in Table 1 were compounded in a twin-screw extruder (ZSK-25) (Werner and Pfleiderer, Germany, Stuttgart) at a speed of 220 rpm and with a throughput of 20 kg/h at a melt temperature in the region of 260° C. and, after cooling and solidification of the melt of the compound, were granulated. The pressure in the degassing zone of the extruder was in each case 200 mbar.

In Comparison Example 1, components A, C and D1 to D3 were first mixed in a powder mixer from Mixaco Dr. Herfeld GmbH & Co. KG Maschinenfabrik (Germany, Neuenrade). The pulverulent mixture so prepared, together with the two thermoplastic polymers TP 1 and TP 2, was metered into the intake zone of the twin-screw extruder, melted in a kneading and mixing zone and the various components were dispersed in one another, and the melt of the polymer alloy so prepared was then degassed in the degassing zone.

In Example 2 according to the invention, components A and B were first premixed with one another in the powder mixer from Mixaco Dr. Herfeld GmbH & Co. KG Maschinenfabrik (Germany, Neuenrade). The water (component B) was absorbed completely by the graft polymer (component A), so that this step yielded a homogeneous pulverulent mixture whose pouring and metering behaviour did not differ from that of component A. Components D1 to D3 were added to this premixture, and mixing was again carried out using the Mixaco mixer. The pulverulent mixture so prepared, together with the two thermoplastic polymers TP 1 and TP 2, was metered into the intake zone of the twin-screw extruder, melted in a kneading and mixing zone and the various components were dispersed in one another, and the melt of the polymer alloy so prepared was then degassed in the degassing zone.

The granulates resulting from the compounding in each case were processed to test specimens in an injection-moulding machine (Arburg) at a melt temperature of 260° C. and a tool temperature of 80° C.

The notched impact strength [ak] of the compositions prepared was determined at 23° C. according to ISO 180-1A on test specimens measuring 80 mm×10 mm×4 mm.

As a measure of the low-temperature strength of the prepared compositions, a puncture test was carried out in accordance with ISO 6603-2 at −20° C. on test specimens measuring 60 mm×60 mm×2 mm, and the maximum energy absorption Ep was determined.

The heat distortion resistance was assessed by means of the Vicat B120 value measured according to ISO 306 on test specimens measuring 80 mm×10 mm×4 mm.

The melt flowability is assessed on the basis of the melt volume flow rate (MVR) measured according to ISO 1133 at a temperature of 260° C. and with a 5 kg die load.

The surface quality was assessed visually on sheets measuring 15 cm×10 cm×3 mm. The number of defects in the surface was assessed on the basis of non-dispersed carbon black-graft agglomerates.

TABLE 1
Formulations and properties of the exemplary compositions

| | C1 | 2 |
|---|---|---|
| Composition | | |
| A | 6.82 | 6.82 |
| B | — | 1.00 |
| C | 0.99 | 0.99 |
| D1 | 0.73 | 0.73 |
| D2 | 0.10 | 0.10 |
| D3 | 0.79 | 0.79 |
| TP1 | 73.04 | 73.04 |
| TP2 | 17.53 | 17.53 |
| Properties | | |
| aₖ (23° C.) [kJ/m²] | 18 | 46 |
| Ep (−20 J) [J] | 44 | 50 |
| MVR [ml/10 min] | 27 | 27 |
| Vicat B120 [° C.] | 133 | 134 |
| Defects on the surface | yes | no |

A comparison of Examples 1 (comparison) and 2 (example according to the invention) shows that, by adding about 13 wt. % water, based on the sum of components A and B, and keeping the compounding process otherwise unchanged (with the same specific energy input), the dispersion of the carbon black in the thermoplastic impact-modified polycarbonate composition can be markedly improved. The improved dispersion of the carbon black manifests itself firstly in an improvement in the notched impact strength and low-temperature ductility and secondly in a significant improvement in the surface quality (reduced number of defects=reduced number of imperfections) of injection-moulded mouldings. The addition of the water evidently does not cause degradation of the polymers, in particular hydrolytic degradation of the polycarbonate, which would manifest itself as an increase in the MVR, which is not observed. Furthermore, all the water supplied during the preparation of the powder mixture can obviously be removed from the polymer composition again via the degassing in the compounding step, because residual amounts of water would lead to a lowering of the Vicat B120 value, which is likewise not observed.

Although dispersion problems occur in particular with pigments that have strong interparticular bonding forces (van der Waals forces) such as carbon-based pigments as shown in the above examples, in principle the invention of improving pigment dispersion also works with pigments other than carbon black. Thus the examples are not intended to restrict in any way the scope of the present invention.

1. A mixture comprising
A) from 60 to 98 parts by weight, based on the sum of components A and B, of at least one graft polymer, in powder form, comprising a rubber-elastic core and a grafted polymer component as a shell,
B) from 2 to 40 parts by weight, based on the sum of components A and B, of at least one inorganic or organic liquid compound, and
C) at least one pigment, wherein, upon use of said mixture in a thermoplastic polymer compounding process, the graft polymer A and/or the pigment C absorbs or adsorbs the liquid inorganic or organic compound B, and the boiling point of component B at normal pressure is below a temperature utilized in the compounding process.

2. A mixture according to claim 1 comprising
A) from 75 to 92 parts by weight, based on the sum of components A and B, of at least one graft polymer, in powder form, comprising a rubber-elastic core and a grafted polymer component as a shell and
B) from 8 to 25 parts by weight, based on the sum of components A and B, of at least one inorganic or organic liquid compound.

3. A mixture according to claim 1, wherein the pigment C is selected from the group consisting of carbon black, graphite, fullerene, graphene, activated carbon and carbon nanotubes.

4. A mixture according to claim 1, wherein component B is at least one selected from the group consisting of water, methanol, ethanol, n-propanol, isopropanol, dimethylformamide, acetone, n-hexane, cyclohexane, n-heptane, n-octane, and toluene.

5. A mixture according to claim 1, wherein component B comprises water.

6. A mixture according to claim 1, wherein component B is a single-phase mixture of water and at least one further liquid that is partially or completely miscible with water, the amount of water being at least 90 wt. %.

7. A mixture according to claim 1, wherein the ratio of component A to component C is from 3:1 to 50:1.

8. A mixture according to claim 1, wherein the mixture comprises at least one further component D in powder form selected from the group consisting of ground thermoplastic polymers, flameproofing agents, flameproofing synergists, smoke-inhibiting additives, antidripping agents, internal and external lubricants and demoulding agents, flowability aids, antistatics, conductivity additives, nucleating agents, stabilisers, additives having antibacterial action, additives that improve scratch resistance, IR absorbers, optical brighteners, fluorescent additives, fillers and reinforcing substances, colourings and pigments beyond the definition of component C, impact modifiers beyond the definition of component A, and Brönstet-acidic compounds.

9. A mixture according to claim 1, wherein the mixture comprises at least one thermoplastic polymer TP or at least one component D in granulate form in an amount of from 1 to 10 parts by weight, based on the sum of all components in said mixture.

10. Process for the preparation of an impact-modified thermoplastic composition comprising at least one pigment, in which
(i) in a first process step, preparing a mixture comprising
A) from 60 to 98 parts by weight, based on the sum of components A and B, of at least one graft polymer, in powder form, comprising a rubber-elastic core and a grafted polymer component as a shell,
B) from 2 to 40 parts by weight, based on the sum of components A and B, of at least one inorganic or organic liquid compound,
and
C) at least one pigment,
wherein the graft polymer A and/or the pigment C absorbs or adsorbs the liquid inorganic or organic compound B,
(ii) and in a second process step, mixing, melting and dispersing in one another the following to form an alloyed polymer melt from 20 to 99 parts by weight, based on the sum of the components used in the second process step, of a component (TP) selected from the group consisting of at least one thermoplastic polymer or a mixture of at least one thermoplastic polymer and at least one graft polymer consisting of a rubber-elastic core and a grafted polymer component as a shell according to component A,
from 1 to 80 parts by weight, based on the sum of the components used in the second process step, of the mixture prepared in process step (i), and
optionally up to 40 parts by weight, based on the sum of the components used in the second process step, of further components
and wherein the inorganic or organic compound B is removed from the alloyed polymer melt by application of a partial vacuum, and wherein the boiling point of component B at normal pressure (1 bar) is below the temperature of the polymer melt upon application of said partial vacuum.

11. Process according to claim 10, wherein component B comprises water.

12. Process according to claim 10, wherein component B is a single-phase mixture of water and at least one further liquid that is partially or completely miscible with water, the amount of water being at least 90 wt. %.

13. Process according to claim 10, wherein component C comprises carbon black.

14. Process according to claim 13, wherein the carbon black according to component C has a BET surface area, determined by nitrogen adsorption according to ISO 4652, of at least 100 m²/g and an oil adsorption number, measured with dibutyl phthalate according to ISO 4656, of from 40 to 120 ml/100 g.

15. A composition prepared according to the process according to claim 10.

16. A moulded article produced from a composition of claim 16.

17. A method for preparing an impact-modified thermoplastic composition comprising at least one pigment comprising:
(i) preparing a mixture comprising
A) from 60 to 98 parts by weight, based on the sum of components A and B, of at least one graft polymer, used in powder form, comprising a rubber-elastic core and a grafted polymer component as a shell,
B) from 2 to 40 parts by weight, based on the sum of components A and B, of at least one inorganic or organic liquid compound, and
C) at least one pigment, and
(ii) preparing a polymer melt from said mixture and at least one thermoplastic polymer, wherein the graft polymer A and/or the pigment C absorbs or adsorbs the liquid inorganic or organic compound B, and wherein the inorganic or organic compound B is removed from the polymer melt by application of a partial vacuum, and wherein the boiling point of component B at normal pressure (1 bar) is below the temperature of the polymer melt upon application of said partial vacuum.

18. A process according to claim 17, wherein the pigment C is selected from the group consisting of carbon black, graphite, fullerene, graphene, activated carbon and carbon nanotubes.

19. A process according to claim 17, wherein component B is at least one selected from the group consisting of water, methanol, ethanol, n-propanol, isopropanol, dimethylformamide, acetone, n-hexane, cyclohexane, n-heptane, n-octane, and toluene.

20. A process according to claim 17, wherein component B comprises water.
